(19) United States
(12) Patent Application Publication
(10) Pub. No.: US 2018/0265361 A1
(43) Pub. Date: Sep. 20, 2018

(54) Novel Carbon Allotrope

(71) Applicants: Larry Burchfield, Richland, WA (US); Mohamed Al Fahim, Abu Dhabi (AE)

(72) Inventor: Larry Burchfield, Richland, WA (US)

(21) Appl. No.: 15/044,461

(22) Filed: Feb. 16, 2016

Related U.S. Application Data
(60) Provisional application No. 62/117,723, filed on Feb. 18, 2015.

(51) Int. Cl. C01B 32/20; H01B 1/04

(52) U.S. Cl. CPC C01B 32/20; C01B 32/05; H01B 1/04

(57) ABSTRACT

A new carbon allotrope is disclosed comprising an inner ring of 6 carbon atoms, which are characterized by hybridized sp² bonds, as commonly found in graphite structure. Adamene further contains an outer ring of 12 outer carbon atoms which surround and are disposed in the same plane as the inner 6 carbon ring. The 12 carbons existing in the outer ring are characterized by sp³ hybridization, as seen in a diamond structure. The carbon allotrope additionally contains a ring of 12 carbon atoms disposed above or below the plane of the inner 6 carbon ring. These additional 12 carbons are characterized by sp³ hybridized bonding, found in diamond, and more specifically in hexagonal diamond, also known as Lonsdaleite.

### CROSS-REFERENCE TO RELATED APPLICATIONS

This patent application claims the benefit of U.S. Provisional Application Ser. No. 62/117,723, filed on 18 Feb. 2015, titled “A Novel Carbon Allotrope”.

### BACKGROUND OF THE INVENTION

### Field of Invention

The invention relates to novel carbon allotrope and compositions and uses thereof.

### Description of Related Art

Elemental carbon occurs throughout nature in a wide variety of allotropic forms. This wide variety of allotropic forms is attributed to carbon being the only element in the periodic table known to have isomers with 0, 1, 2, or 3 dimensions. The carbon atom can hybridize electronic slates in several different valence bonds which allows for a variety of different atomic bonding configurations. The isomers can have sp, sp² or sp³ hybridization in the valence electron orbitals.

As can be seen in FIG. 1A through 1H there are eight known allotropes of carbon: a) diamond, b) graphite. c) Lonsdaleite, d) C60 (Buckminsterfullerene or buckyball), e) C540, f) C70, g) amorphous carbon, and h) single-walled carbon nanotube, or buckytube.

Diamond is one of the most well-known carbon allotrope. The carbon atoms are arranged in a lattice, which is a variation of the face-centered cubic crystal structure. Each carbon atom in a diamond is covalently bonded to four other carbons in a tetrahedron, as seen in FIG. 1A. These tetrahedrons together form a three-dimensional network of six-membered carbon rings in the chair conformation, allowing for zero bond-angle strain. This stable network of covalent bonds and hexagonal rings is the reason that diamond is so incredibly strong as a substance.

As a result, diamond exhibits the highest hardness and thermal conductivity of any bulk material. In addition, its rigid lattice prevents contamination by many elements. The surface of diamond is lipophillic and hydrophobic, which means it cannot get wet by water but can be in oil. Diamonds do not generally react with any chemical reagents, including strong acids and bases.

Graphite is another allotrope of carbon and unlike diamond, it is an electrical conductor and a semi-metal. Graphite is the most stable form of carbon under standard conditions and is used in thermochemistry as the standard state for defining the heat of formation of carbon compounds. As seen in FIG. 1B, graphite has a layered, planar structure. In each layer, the carbon atoms are arranged in a hexagonal lattice with separation of 0.142 nm, and the distance between planes (layers) is 0.335 nm. The two known forms of graphite, alpha (hexagonal) and beta (rhombohedral), have very similar physical properties (except that the layers stack slightly differently). The hexagonal graphite may be either flat or buckled. The alpha form can be converted to the beta form through mechanical treatment, and the beta form reverts to the alpha form when it is healed above 1300° C. Graphite can conduct electricity due to the vast electron delocalization within the carbon layers; as the electrons are free to move, electricity moves through the plane of the layers.

A single layer of graphite is called graphene. This material displays extraordinary electrical, thermal, and physical properties. It is an allotrope of carbon whose structure is a single planar sheet of sp³ bonded carbon atoms that are densely packed in a honeycomb crystal lattice. The carbon-carbon bond length in graphene is ˜0.142 nm, and these sheets stack to form graphite with an interplanar spacing of 0.335 nm. Graphene is the basic structural element of carbon allotropes such as graphite, charcoal, carbon nanotubes, and fullerenes. Graphene is a semi-metal or zero-gap semiconductor, allowing it to display high electron mobility at room temperature.

Another known allotrope of carbon, Lonsdaleite, is also known as “hexagonal diamond”, due to its crystal structure which has a hexagonal lattice, which is depicted in FIG. 1C. The diamond structure is typically made up of interlocking six carbon atoms, which exist in the chair conformation. However, in Lonsdaleite, some rings are in the boat conformation instead. In diamond, all the carbon-to-carbon bonds, both within a layer of rings and between the layer of rings are in the staggered conformation, which causes all four cubic-diagonal directions to be equivalent. Whereas in Lonsdaleite, the bonds between the layers are in the eclipsed conformation, which defines the axis of hexagonal symmetry.

Amorphous carbon refers to carbon that does not have a crystalline structure, as is evident by the structure depicted in FIG. 1G. Even though amorphous carbon can be manufactured, there still exist some microscopic crystals of graphite-like or diamond-like carbon. The properties of amorphous carbon depend on the ratio of sp² to sp³ hybridized bonds present in the material. Graphite consists purely of sp² hybridized bonds, whereas diamond consists purely of sp³ hybridized bonds. Materials that are high in sp³ hybridized bonds are referred to as tetrahedral amorphous carbon (owing to the tetrahedral shape formed by sp³ hybridized bonds), or diamond-like carbon (owing to the similarity of many or its physical properties to those of diamond).

Carbon nanomaterials make up another class of carbon allotropes. Fullerenes (also called buckyballs) are molecules of varying sizes composed entirely of carbon that take on the form of hollow spheres, ellipsoids, or tubes. Buckyballs and buckytubes have been the subject of intense research, both because of their unique chemistry and for their technological applications, especially in materials science, electronics, and nanotechnology. Carbon nanotubes are cylindrical carbon molecules that exhibit extraordinary strength and unique electrical properties and are efficient conductors of heat. Carbon nanobuds are newly discovered allotropes in which fullerene-like “buds” are covalently attached to the outer side walls of a carbon nanotube. Nanobuds therefore exhibit properties of both nanotubes and fullerenes.

Pure carbon and its various known allotropic forms described above provide many currently useful commercial and research applications. For example, the high thermal conductivity of diamond along with its electrically insulative properties allows for its widespread use as a heat sink material for certain solid state devices in the microelectronics industry. Graphite has been used successfully as a lubricant and a catalyst support material.

### BRIEF SUMMARY OF THE INVENTION

The present invention provides a new and useful synthetic carbon allotrope, which for purposes of the present disclosure will be termed “Adamene”. Due to the unique chemical structure of the presently disclosed carbon allotrope, compositions comprising the allotrope can be useful for incorporation for a variety of materials, including, but not limited to those utilized for Hall effect sensors, transistors, transparent conducting electrodes and piezoelectric materials.

The carbon allotrope contains an inner hexagonal ring of 6 carbon atoms, which arc characterized by hybridized sp² bonds, as commonly found in graphite structure. Adamene further contains an outer ring of 12 outer carbon atoms which surround and are disposed in the same plane as the inner hexagonal 6 carbon ring. The 12 carbons existing in the outer ring are characterized by sp³ hybridization, as seen in a diamond structure. The carbon allotrope additionally contains a ring of 12 carbon atoms disposed above or below the plane of the inner hexagonal 6 carbon ring. These additional 12 carbons are characterized by sp³ hybridized bonding, found in diamond, and more specifically in hexagonal diamond, also known as Lonsdaleite.

In summary, the Adamene carbon allotrope contains a centrally located hexagonal 6 carbon atom inner ring, which is characterized as a single graphene crystal, surrounded and held in the central position by sp³ hybridized bonded carbons, which are characterized as Lonsdaleite structures. The carbon allotrope has more than one graphene crystal stacked in a plane directly above and/or below another graphene crystal, wherein the two centrally located hexagonal rings of the crystal do not contain interplanar bonds, thereby creating a graphite structure in the core of the molecule. As such, the centrally located hexagonal 6 carbon inner rings are only bonded to the surrounding Lonsdaleite structures and are thereby held in the central position of the allotrope only through this bonding.

This specific structure provides for a new carbon allotrope, which has a graphite central core, and is therefore electrically conductive within the central region of the molecule, while surrounded by a shell of Lonsdaleite structures, which is non-conductive and insulative.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

In the drawings:

FIG. 1A-1H illustrates the structures of various known carbon allotropes.

FIG. 2A-2D illustrates line renderings of carbon allotropes used for comparison with the present allotrope of this invention.

FIG. 3 illustrates a top view of the carbon allotrope of the present invention. Clockwise directional numbering has been inserted around the illustrated allotrope to provide a frame of reference.

FIG. 4 illustrates a side view of the carbon allotrope of the present invention at the 6 o'clock position.

FIG. 5 illustrates a side view of the carbon allotrope of the present invention at the 7 o'clock position.

FIG. 6 illustrates a side view of the carbon allotrope of the present invention at the 8 o'clock position.

FIG. 7 illustrates a side view of the carbon allotrope of the present invention at the 10 o'clock position.

FIGS. 8 and 9 illustrate a top view of a lateral expansion of the carbon allotrope of the present invention.

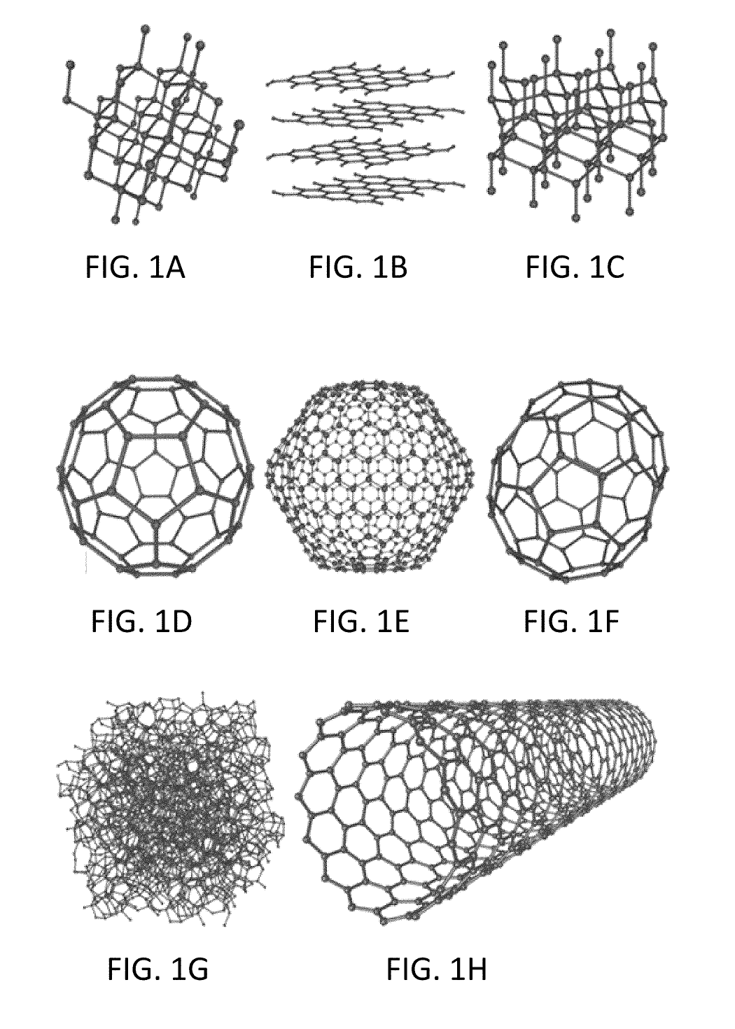

### DETAILED DESCRIPTION OF THE INVENTION

In the following Detailed Description, reference is made to the accompanying drawings, which form a part hereof, and in which is shown by way of illustration specific embodiments in which the invention may be practiced. Wherever possible, the same reference numbers are used in the drawings and the description to refer to the same or like parts. Directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

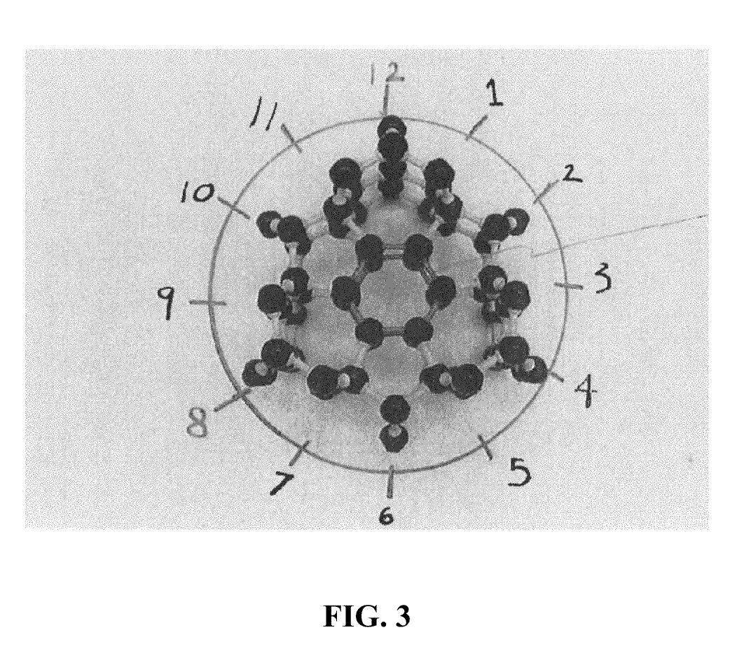

The present invention pertains to a synthetic new carbon allotrope, allotrope which contains an inner hexagonal ring of 6 carbon atoms, which are characterized by hybridized sp² bonds, as commonly found in a graphite structure. FIG. 3 illustrates a top view of the presently disclosed carbon allotrope (wherein clockwise directional numbering has been provided for a frame of reference). Adamene further contains an outer ring of 12 outer carbon atoms which surround and are disposed in the same plane as the inner hexagonal 6 carbon ring. The 12 carbons existing in the outer ring arc characterized by sp³ hybridization, as seen in a diamond structure, and more specifically in Lonsdaleite. The carbon allotrope additionally contains a ring of 12 carbon atoms disposed above or below (depending on the frame of reference) the plane of the inner hexagonal 6 carbon ring. These additional 12 carbons are characterized by sp³ hybridized bonding, found in Lonsdaleite.

Detailed Structure of Adamene and Comparison with Known Carbon Allotropes.

For purposes of comparison with existing carbon allotropes and for a better understanding of the structure of this novel carbon allotrope, the following is a discussion of known carbon allotropes, including diamond, graphite (where graphene is a single layer of graphite), Lonsdaleite and Buckminsterfullerenes (C60).

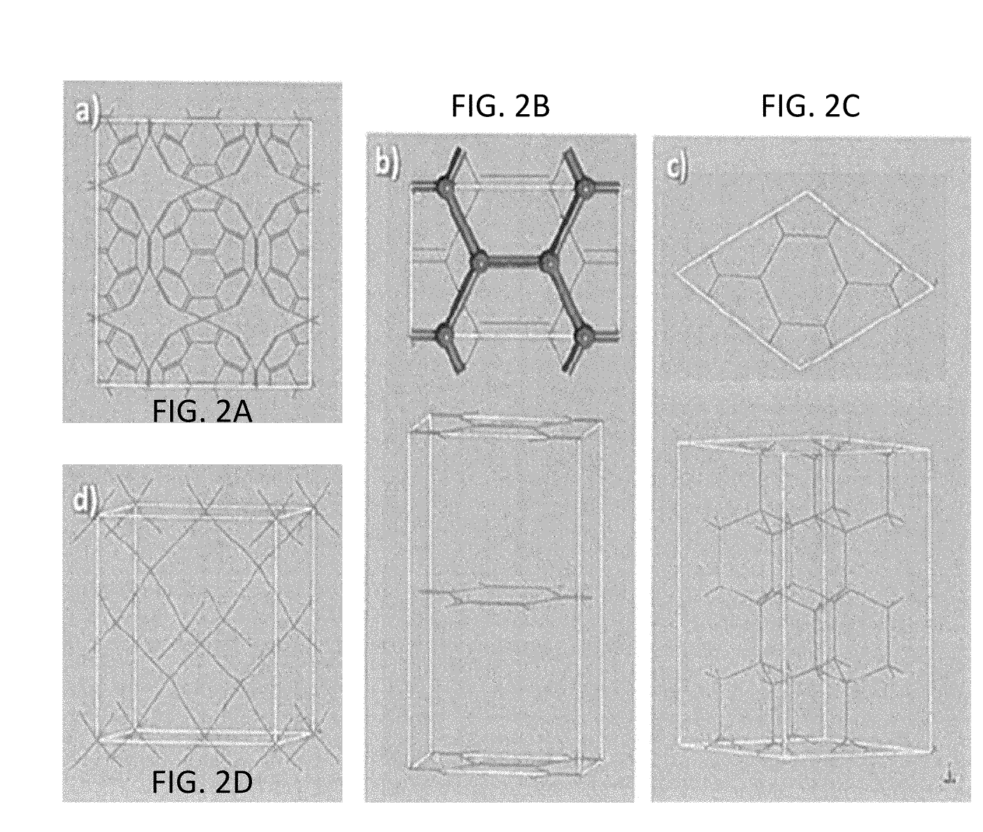

For example, the motif of the single hexagonal rings of carbon surrounded by three carbon pentagons is similar to the fundamental repeating pattern in Buckminsterfullerenes, also known as “buckyballs”, as depicted in FIG. 2A. Buckyballs, are spherical fullerene molecules with the formula C60. They have a cage-like fused-ring structure which resembles a soccer ball, made of twenty hexagons and twelve pentagons, with a carbon atom at each vertex of each polygon and a bond along each polygon edge.

In the buckyball structure, the carbon to carbon distances in the hexagonal rings surrounded by a total of six alternating pentagons and hexagons are on the order of 1.45-1.49 Angstroms. It is the folding up of these alternating hexagons and pentagons surrounding the central hexagonal carbon ring that leads to the classic ball shape of fullerenes. In contrast, the grouping of three pentagons surrounding a central hexagonal ring remains “in plane” in the present carbon allotrope structure, however, members of the six and seven atom carbon rings “pop up” to the next plane.

With respect to the vertical spacing of the 6 carbon inner hexagonal rings in the presently disclosed Adamene structure, which are not bonded together, graphite shown in FIG. 2B and Lonsdaleite, shown in FIG. 2C lend a useful comparison.

In graphite, infinite sheets of hexagonal carbon rings make up the layered characteristic of this structure. The hexagonal layers in graphite are offset by half a unit cell between the layers, that is, a carbon ring in one layer does not sit exactly above a carbon ring in the next layer, as can be seen in FIG. 2B. Carbon-to-carbon distances in the rings of graphite are approximately 1.418 Angstroms and each layer is separated by 3.348 Angstroms perpendicular to the carbon sheets.

Another known allotrope of carbon, Lonsdaleite, is also known as “hexagonal diamond”, due to its crystal structure which has a hexagonal lattice. The diamond structure of typically made up of interlocking six carbon atoms, which exist in the chair conformation. However, in Lonsdaleite, some rings are in the boat conformation instead. In diamond, all the carbon-to-carbon bonds, both within a layer of rings and between the layer of rings are ln the staggered conformation, which causes all four cubic-diagonal directions to be equivalent. Whereas in Lonsdaleite, the bonds between the layers are in the eclipsed conformation, which defines the axis of hexagonal symmetry.

In Lonsdaleite, the hexagonal carbon rings are situated directly on top of one another between layers, as is shown in FIG. 2C. The rings however are kinked rather than planar, such that the shorter carbon-to-carbon distances, about 1.545 Angstroms, are bonded between planes, while longer carbon-to-carbon distances of 2.575 Angstrom remain unbonded. Additional bonding constraints are the carbon-to-carbon distances in the hexagonal rings, of 1.543-1.545 Angstroms, and these rings are connected both inplane and perpendicular to the plane.

Lastly, in the present Adamene carbon allotrope, it can be said that a diamond-like, Lonsdaleite structure aids in connecting the repeating units to one another. In diamond, every carbon is bonded to four other carbon atoms in a tetrahedral conformation, as depicted in FIG. 2D. The carbon atoms are arranged in a variation of the face-centered cubic crystal structure called a diamond lattice. The diamond allotrope has bond lengths of 1.544 Angstroms in all directions.

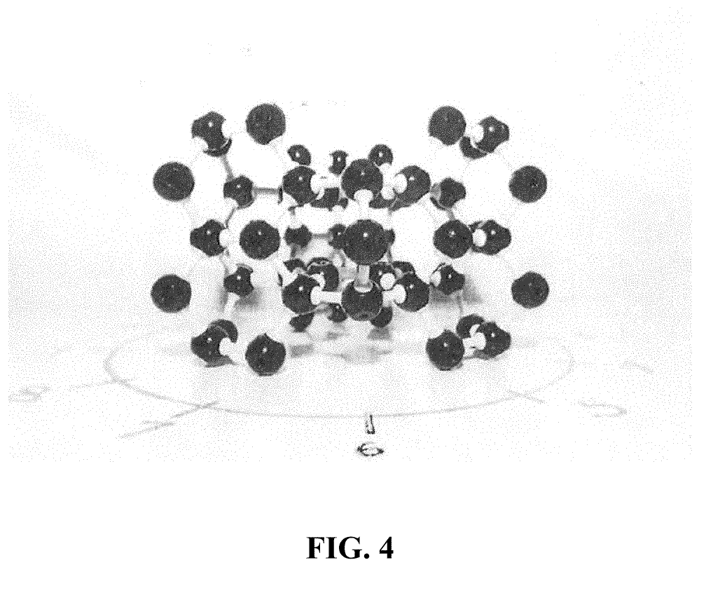

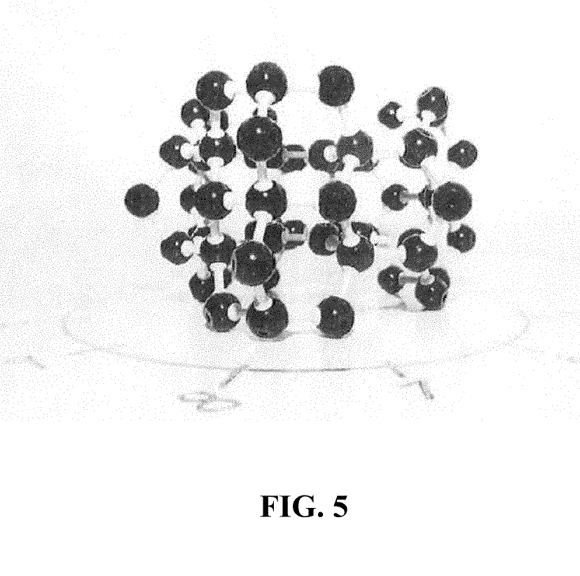

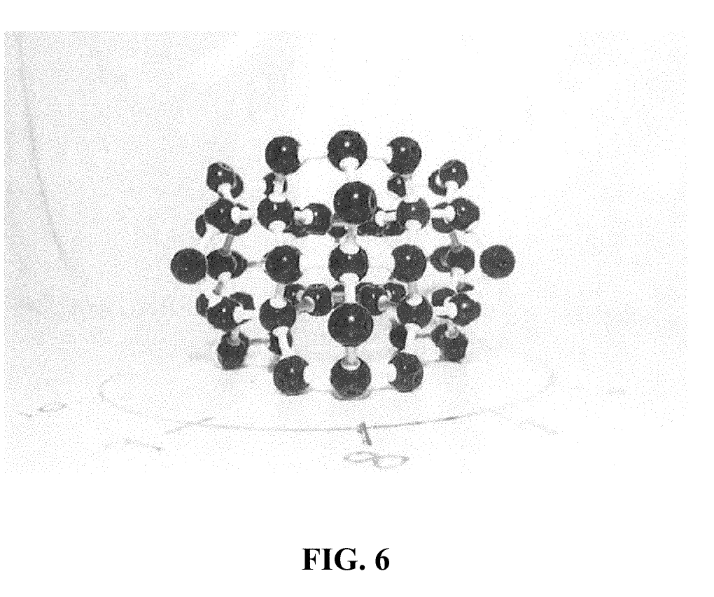

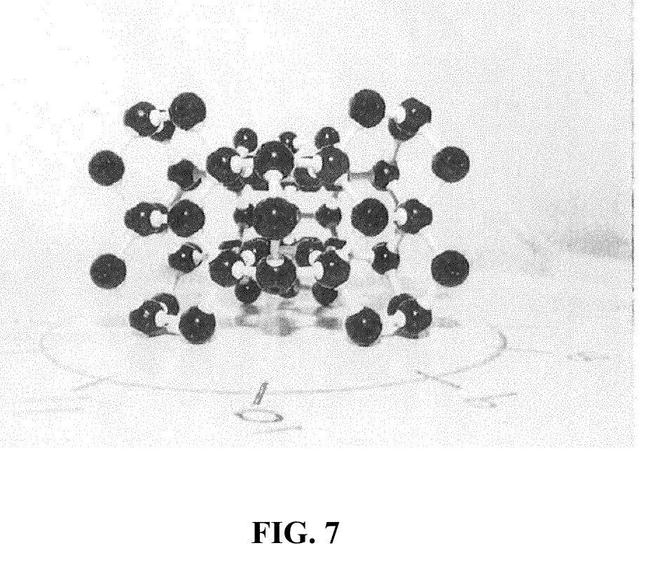

Referring now to FIG. 3, the carbon allotrope of the present invention is shown, using a three dimensional ball-and-stick model. FIG. 3 depicts the molecule from a top view looking down the z-axis (perpendicular to the page). The inner ring of the carbon allotrope, consisting of six bonded carbons, can be seen by the dark grey bonds which form a hexagonal inner ring structure, and are characterized by sp² hybridized bonds, as in a graphene crystal. As can be seen from the top view of FIG. 3 and by the side views of FIGS. 4 through 7, the inner graphene portion of the presently disclosed carbon allotrope, is represented by the dark grey bonded inner hexagonal ring of 6 carbon atoms. In FIGS. 3-7, three carbon atoms from the top and bottom layers have been omitted for better clarity and viewing of the model of the carbon allotrope.

As can be seen in FIG. 3, the hexagonal inner ring, i.e. the graphene portion of the allotrope, lies on top of a repeating additional hexagonal inner ring, and the two inner rings are not bonded to each other. Rather it's the outer bonded carbons, which create Lonsdaleite structures which hold the graphene rings in the center of the present carbon allotrope, as they surround the inner rings. The Lonsdaleite portion of the allotrope is represented in FIG. 3 by the white bonds attaching the outer carbon atoms, surrounding the 6 carbon atoms making up the hexagonal inner ring. All atoms are bonded to four other atoms in this structure, except for those in the hexagonal inner rings, which are only bonded to three other carbon atoms.

The inner ring carbons shown in FIG. 3 are characterized by sp² hybridization. Each carbon atom in the inner ring undergoes sp² hybridization and the unhybridized p-orbitals on each carbon atoms overlap sideways to produce a pi system above and below the plane of the inner ring. Whereas, the outer carbon atoms, as previously discussed, are bonded by white bonds in FIG. 3 and are characterized by sp³ hybridization, found in diamond formations, and more specifically in Lonsdaleite.

Therefore, it can be said that the presently disclosed carbon allotrope consist of a centralized graphite core backbone, which is held together by surrounding Lonsdaleite structures. The Lonsdaleite structures include interlocking 6 carbon rings in chair or boat conformations. The bonds between the layers are in eclipsed conformation, which defines the axis of the hexagonal symmetry.

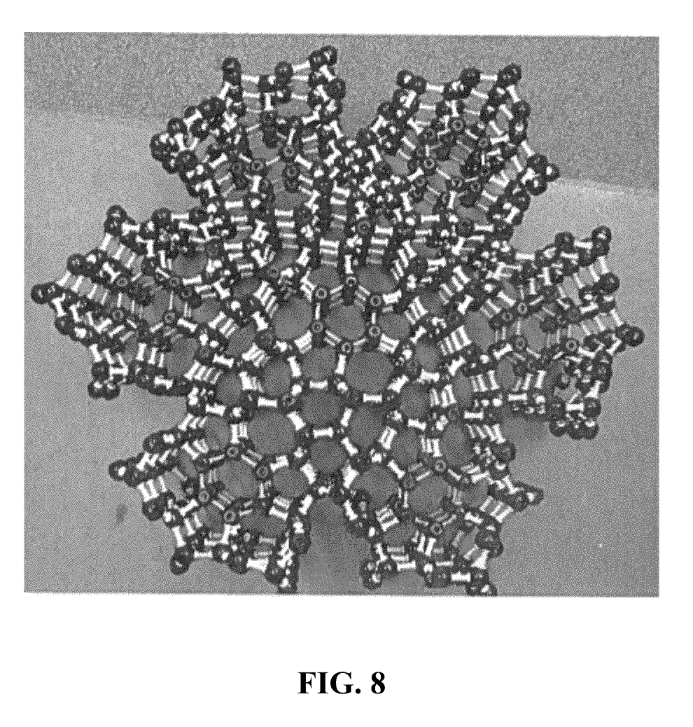

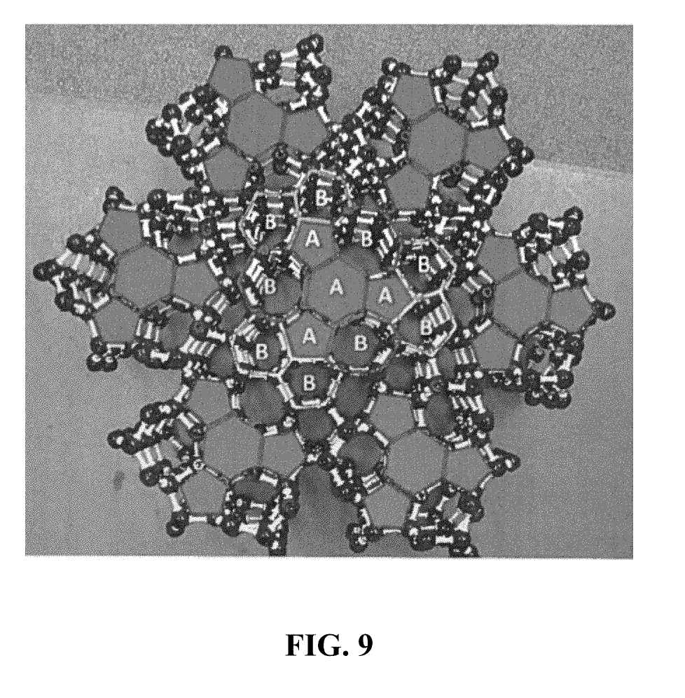

Referring now to FIGS. 8 and 9 a lateral expansion of the Adamene molecule can be seen viewed from the top through a vertical axis z. Again here, dark grey bonds represent the inner hexagonal 6 carbon rings, whereas the white bonded carbons represent the outer surrounding Lonsdaleite structures, which hold the stacked graphene crystals in a central position within the molecule. FIG. 9 is a modified illustration of FIG. 8, which shows shaded hexagons and pentagons representing a repeat-unit that lies within a same plane (A), which is one layer down from the top-most plane (B) of the molecule. The dark grey and light grey hollow polygon rings represent 7-member carbon rings and 6-member carbon rings, respectively, where atoms that share points with the shaded shapes lie in the same plane (A), and all other atoms reside in the next plane up (B). This expanded model of the molecule contains seven stacked layers perpendicular lo the z-axis in the following pattern from the top down: B-A-B-A-B-A-B.

An approximation of spacing between A and B layers of the present carbon allotrope reveals that the non-bonded distances of the hexagonal rings between A and B layers are on the order of 2.6 Angstroms. Carbon-to-Carbon distances for the 5-membered and 6-membered rings in the A plane, as shown in FIG. 9, are estimated to be on the order of 1.452 Angstroms. Whereas bond lengths for the 6 and 7-membered rings in the B layer are estimated to be on the order of 1.397-1.703 Angstroms. A carbon-to-carbon bond length of 1.752 connects layer A to layer B and a distance of 2.736 Angstroms separates non-bonded layers (e.g. layer A to layer A along the vertical z-axis).

Properties and Utilization of the Carbon Allotrope.

Graphene is known to behave as a zero-gap semiconductor, allowing it to display high electron mobility at room temperature. It can function as either a n-type or p-type semiconductor, which makes it a far more versatile component than regular silicon based semiconductors. Graphene also exhibits a pronounced response to perpendicular external electric files, which aid in its potential utilization as a field-effect transistor (FET). Additionally, graphene's high electrical conductivity and high optical transparency make it a suitable candidate for utilization in transparent conducting electrodes, which are required for such applications as touchscreens, liquid crystal displays, organic photovoltaic cells and organic light emitting diodes.

In particular, graphene's mechanical strength and flexibility are highly advantageous when compared to prior metallic or metal oxide based films used in many of the above applications, which are known to be brittle and thereby undesirable for various applications, especially those which require a mechanically stable but flexible component.

Due to its various unique chemical and physical properties graphene has been shown to be successfully utilized in various applications and components, including, but not limited to, integrated circuits, optoelectronics, Hall effect sensors, quantum dots, optical absorption/modulation, infrared light detection, photovoltaic cells, conductive electrodes, fuel cells, supercapacitors, molecular absorption sensors and piezoelectric devices.

Due to the unique structure of the presently disclosed carbon allotrope, which includes an electron conducting graphene based central portion surrounded by an insulating outer Lonsdaleite structure, various of the above mentioned applications and devices can advantageously incorporate compositions of the carbon allotrope. For example, for the production of integrated circuits, the incorporation of the presently disclosed carbon allotrope would provide high carrier mobility due to the central graphene core, while resulting in low noise due to the insulating properties of the outer Lonsdaleite structures.

Doping and Synthesis Methods of the Carbon Allotrope.

For further enhancement of conducting capabilities the carbon allotrope is capable of being doped with a metal element, including but not limited to gold or silver.

Further doping with heteroatoms such as boron, nitrogen, sulfur, phosphor and silicon is also envisioned. The purpose of heteroatomic doping is aimed at altering some of the important properties of the graphene portion of the allotrope, including electrical (electron density and semiconducting character), mechanical (improvement of Young's modulus), and chemical (change of reactivity, creation of catalytically active centers). There are three basic ways that nitrogen can be incorporated into the graphene structure of the carbon allotrope. (1) Substitution, where N is coordinated to three C atoms in sp² like fashion, which induces sharp localized states above the Fermi level associated with the injection of additional electrons into the structure. (2) Pyridine-like substitution, where N is arranged around a vacancy, since the valency of the nitrogen can be satisfied by two sp² bonds, a delocalised p-orbital, and a lone pair in the remaining sp² orbital, pointing at the vacancy. (3) Chemical adsorption of N2 molecules. Nitrogen contains one electron more than carbon; therefore, substitutional doping of nitrogen within graphene will n-dope the structure, enhancing the number of electronic states at the Fermi level depending on the location and concentration of dopant.

The presently disclosed carbon allotrope can be synthesized through various techniques presently known and existing in the art. These include but are not limited to chemical vapor deposition (CVD), plasma enhanced chemical vapor deposition (PECVD), filament assisted chemical vapor deposition, arc discharge or laser ablation methods and molecular printing. The CVD method is commonly known in the art, and utilizes a carbon containing source, usually in gaseous form, which is decomposed at elevated temperatures and passes over a transition metal catalyst (typically Fe, Co, Ag or Ni). CVD is known to produce a high yield of carbon allotropes, although more accurate structures arc generally capable of production through arc deposition or laser ablation methods.

While selected embodiments have been selected to be illustrated of the present invention, and specific examples have been described herein, it will be obvious to those skilled in the art that various changes and modifications may be aimed to cover in the appended claims. It will, therefore, be understood by those skilled in the art that the particular embodiments of the invention presented here are by way of illustration only, and are not meant to be in any way restrictive; therefore, numerous changes and modifications may be made, and the full use of equivalents resorted to, without departing from the spirit or scope of the invention as outlined in the appended claims.

1. A composition of matter comprising:
a carbon allotrope having an inner hexagonal ring of six carbon atoms, an outer ring of twelve carbon atoms surrounding said inner hexagonal ring,
wherein the said outer ring of twelve carbon atoms lies in the same plane as the inner hexagonal ring of six carbon atoms,
said carbon allotrope additionally comprising twelve carbon atoms lying in a plane above or below said inner hexagonal ring.

2. A composition of matter according to claim 1, wherein said six carbon atoms of said inner hexagonal ring in the carbon allotrope are characterized by sp² hybridized bonds.

3. A composition of matter according to claim 1, wherein said six carbon atoms of said inner hexagonal ring in the carbon allotrope represent a single graphene crystal.

4. A composition of matter according to claim 1, wherein said twelve carbon atoms of said outer ring and said twelve carbon atoms lying in said plane above or below said inner hexagonal ring are characterized by sp³ hybridized bonds.

5. A composition of matter according to claim 1, wherein said inner hexagonal ring of six carbon atoms lies in a plane directly above or below at least one repeating additional inner hexagonal ring of six carbon atoms,
wherein said inner hexagonal ring and said at least one repeating additional inner hexagonal ring are not bonded to each other, and
wherein said at least one repeating additional inner hexagonal ring is bonded to an additional outer ring of twelve carbon atoms surrounding said at least one additional inner hexagonal ring.

6. A composition of matter according to claim 5, wherein said carbon allotrope exhibits interplanar spacing between said inner hexagonal ring and said at least one repeating additional inner hexagonal ring characterized by a carbon-to-carbon bond distance of about 2.6 Angstroms.

7. A composition of matter according to claim 1, wherein said carbon allotrope has interplanar spacing between the plane wherein said inner hexagonal ring resides and the plane above or below, characterized by a carbon-to-carbon bond length of 1.752 Angstroms.

8. A composition of matter according to claim 1, wherein the carbon allotrope is doped with a metallic element, selected from a group consisting of silver and gold.

9. A composition of matter according to claim 1, wherein the carbon allotrope is doped with a heteroatom, selected from a group consisting of boron, nitrogen, sulfur, phosphor and silicon.

10. A composition of matter according to claim 1, wherein the carbon allotrope is doped with an n-type or p-type material for the formation of a transistor.

11. A composition of matter according to claim 1, wherein the carbon allotrope in said composition is incorporated in devices or applications selected from a group consisting of integrated circuits, optoelectronic devices, semiconductor devices, Hall effect sensors, quantum dots, optical absorption/modulation device, infrared light detection devices, photovoltaic cells, conductive electrodes, fuel cells, supercapacitors, molecular absorption sensors and piezoelectric devices.

12. A composition of matter comprising:
a carbon allotrope comprising a central inner graphene portion, and a Lonsdaleite portion, wherein the Lonsdaleite portion is bonded to and surrounds said central inner graphene portion.

13. A composition of matter according to claim 12, wherein said central inner graphene portion is characterized by sp² hybridized bonds and said surrounding Lonsdaleite portion is characterized by sp³ hybridized bonds.

14. A composition of matter according to claim 12, wherein the carbon allotrope is doped with a heteroatom, selected from a group consisting of boron, nitrogen, sulfur, phosphor and silicon.

15. A composition of matter according to claim 12, wherein the carbon allotrope is doped with an n-type or p-type material for the formation of a transistor.

16. A composition of matter according to claim 12, wherein the carbon allotrope in said composition is incorporated in devices or applications selected from a group consisting of integrated circuits, optoelectronic devices, semiconductor devices, Hall effect sensors, quantum dots, optical absorption/modulation device, infrared light detection devices, photovoltaic cells, conductive electrodes, fuel cells, supercapacitors, molecular absorption sensors and piezoelectric devices.
